(19) United States
(12) Patent Application Publication
(10) Pub. No.: US 2006/0054103 A1
(43) Pub. Date: Mar. 16, 2006

(54) Infected poultry treatment system and method thereof

(75) Inventors: Hsiu-Ting Chang, Tainan County (TW); Yu-Ting Chang, Tainan County (TW); Ting-Ting Chang, Tainan County (TW)

Correspondence Address: BACON & THOMAS, PLLC, 625 SLATERS LANE, FOURTH FLOOR, ALEXANDRIA, VA, 22314, US

(73) Assignee: CHANG' S INTERNATIONAL ENTERPRISE Co., LTD, Tainan County (TW)

(21) Appl. No.: 10/939,497

(22) Filed: Sep. 14, 2004

(51) Int. Cl. A01K 29/00

(52) U.S. Cl. 119/650

(57) ABSTRACT

An infected poultry treatment system is provided. A poultry yard is used to hold the poultry to be treated, and the poultry can be automatically transported to a euthanasia room by a first conveyor. Then, dead poultry is automatically transported to a crusher by a second conveyor to crush the carcasses. The crushed carcasses are then automatically transported to the incinerating means by a third conveyor. And then, ash withdrawal is automatically performed. The present system can be automatically and continuously operated up to at least twenty-four hours, and thus provides high incinerating efficiency as well as preventing the environment from being polluted by waste gases and sewage water.

### BACKGROUND OF THE INVENTION

1. Field of the Invention

The present invention relates to a poultry treatment system, and more particularly to an automatic system for treating infected poultry.

2. Description of the Related Art

When a poultry infection (as bird flu) suddenly erupts, it is necessary to kill infected poultry to inhibit the infection from being spread. As a result, a large quantity of poultry is killed and must be handled. Conventionally, the method of treating the large quantity of dead poultry includes rendering plant processing, land filling and incineration, among other methods.

The purpose of rendering plant processing is to manufacture foodstuff, but the dead infected poultry cannot be used to produce foodstuff due to the infective virus it carries. In other words, the infected dead poultry cannot be rendering plant processing.

Land filling is another method for treating infected dead poultry. It is necessary to select a land filling location as close to the infected zone as possible. Before landfilling the dead poultry, the bottom of a ditch or cavity for placing the dead poultry is pre-covered by a layer of calcium lime (i.e. calcium oxide). Then, the dead poultry is placed into the ditch or cavity. Thereafter, another layer of calcium lime is placed over the top of the ditch or cavity. However, there is a concern as to whether or not there is a sewage water purification pond or water source under the land filling location. The land filling location should be a place far from houses, water sources, rivers and roads, and in a place that animals cannot approach. The decaying poultry carcasses produce foul-smelling gases and sewage water, which permeates from the land filling location. Therefore, when locating a land filling location, it is necessary to consider issues such as whether or not there is any underground water, how to resolve problems subsequent to the land filling, and environmental quality maintenance, among other problems. Alternately, after the dead poultry is placed into the ditch or cavity, gasoline is poured in the ditch or cavity, and then they are burned out.

Incineration is the burning of the poultry carcasses to ash at a high temperature. The incineration can kill viruses and prevent the infection from being spread as well as comply with environmental protection requirements. However, conventional incineration still cannot treat a large quantity of dead infected poultry and effectively prevent the infection from being spread due to the following reasons:
(a) small working capacity: the working capacity of each incinerator is approximately 1000 kilograms per eight hours.
(b) short working time: the working time of each incinerator does not exceed eight hours, and these cannot be continuously operated for up to twenty four hours.
(c) unscientific and non-automatic operation:
   (i) manual feeding mode adversely influences the feeding speed and incinerating capacity.
   (ii) discontinuous incinerating cannot facilitate incineration and negatively influences processing capacity.
   (iii) mass-burning takes a longer time, and cannot effectively deal with dioxin, which limits the processing capacity.
   (iv) incinerating the whole body of the dead poultry, for example, first incinerating the feathers and then the meat, would pollute the atmosphere and adversely influence the incinerating speed.
   (v) the carcass can not be dismembered into pieces for incinerating. However, it is necessary to dismember the carcass to improve the incinerating capacity.
   (vi) the ash withdrawal after the combustion relies on human labor.
   (vii) unmovable incinerators cannot be moved to the infected zones to treat the killed infected poultry.
   (viii) the infected poultry is transported outdoors and then killed, which risks spreading the infection.

The conventional method for treating infected poultry does not resolve the problems encountered in emergency situations once the infection has spread. It is an urgent necessary to develop an improved method and system to overcome the above drawbacks.

### SUMMARY OF THE INVENTION

A large quantity of poultry carcasses are treated by rendering plant processing, incineration and other treatments. Conventional treatment systems cannot provide a sequence of continuous operations, such as continuously feeding, crushing, incinerating and conveying, as well as cannot provide some automatic operations, such as automatically expelling the poultry into a euthanasia room, automatically transporting dead poultry into a crusher and automatically incinerating the crushed carcasses. Neither can the conventional treatment system be transferred to an infected zone to perform in-situ treatment of the infected poultry.

The infected poultry treatment system of the present invention can be transported to the infected zone and quickly treat a large quantity of infected poultry carcasses with continuous and spreading mode of combustion so as to effectively prevent the infection from spreading. The present infected poultry treatment system can comply with environmental protection requirements.

The primary objective of the present invention is to provide an automatic infected poultry treatment system, by which the entire treatment process is automatically performed, including continuous feeding, continuous conveying, continuous incinerating, as well as automatic ash withdrawal, automatic expelling of the poultry into the euthanasia room, automatic transporting of the poultry carcasses into the crusher, and automatic incineration. The present system can be disassembled and transported to the infected zone to treat the infected poultry.

Another objective of the present invention is to provide a method for treating infected poultry, which includes the steps of expelling the infected poultry, a euthanasia process, crushing the poultry carcasses and incinerating the same.

In order to achieve the above objectives, the present invention provides an infected poultry treatment system, which includes a poultry yard for holding the poultry to be treated; a euthanasia room gasing the infected poultry; a crusher; a means for incinerating the carcasses; a first conveyor for transporting the poultry from the poultry yard to the euthanasia room; a second conveyor for transporting the dead poultry from the euthanasia room to the crusher; and a third conveyor for transporting the dead poultry from the crusher to the incinerator.

It is preferable that the poultry yard further includes a fence, by which the space for the poultry in the poultry yard can be narrowed.

It is preferable that the poultry yard further includes an expelling mechanism. The expelling mechanism is used to expel the poultry in the poultry yard to the first conveyor so that the poultry can be transported to the euthanasia room by the first conveyor.

It is preferable that the euthanasia room is provided with a gas injection means, by which gas is introduced into the euthanasia room.

The objectives and characteristics of the present invention as stated above are further described in detail based on the drawings shown below. However, it should be noted that the drawings and the preferred embodiments referred to herein are merely for the purpose of detailed description, and therefore, do not confine or limit the present invention.

### BRIEF DESCRIPTION OF THE DRAWINGS

FIG. 1 is a schematic block diagram of an infected poultry treatment system according to a first embodiment of the present invention;

FIG. 2 is a schematic block diagram of an infected poultry treatment system according to a second embodiment of the present invention; and

FIG. 3 is a schematic flow chart of a method of treating infected poultry of the present invention.

### DETAILED DESCRIPTION OF THE INVENTION

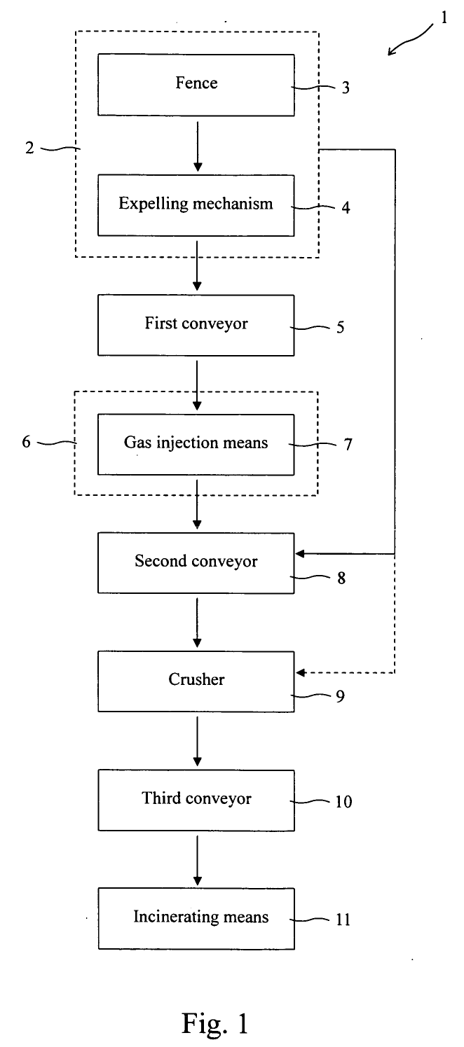

FIG. 1 is a schematic block diagram of the present infected poultry treatment system 1 according to the first embodiment of the present invention, which includes a poultry yard 2, a first conveyor 5, a euthanasia room 6, a second conveyor 8, a crusher 9, a third conveyor 10 and an incinerating means 11. The poultry yard 2 is used for holding the poultry to be treated and has a fence 3 and an expelling mechanism 4. The fence 3 is used to narrow the space of the poultry in the poultry yard 2. The expelling mechanism 4 is used to expel the poultry in the poultry yard 2 to the first conveyor 5 so as to transport the poultry to the euthanasia room 6 by the first conveyor 5. The euthanasia room 6 has a gas injection means 7 to introduce gas into the euthanasia room 6 to kill the poultry. The dead poultry is transported from the euthanasia room 6 to the crusher 9 by the second conveyor 8. The crusher 9 crushes the dead poultry. The crushed carcasses are transported to the incinerating means 11 by the third conveyor 10. The carcass chunks are incinerated in the incinerating means 11.

The poultry yard 2 is a closed-type space. When the poultry keeper wants to kill all the poultry in the poultry yard 2, first, the fence 3 is used to narrow the space in the poultry yard. In the meantime, the expelling mechanism 4 is driven by an external driving mechanism (not shown) such that the expelling mechanism 4 in cooperation with the fence 3 expels the poultry in the poultry yard 2 to the first conveyor 5. Then, the poultry is transported to the euthanasia room 6 by the first conveyor 5.

The euthanasia room 6 is a sealed chamber with the gas injection means 7. The gas injection means 7 introduces gas, such as carbon dioxide, into the euthanasia room 6 to kill the poultry. The bottom of the euthanasia room 6 is automatically opened by a control switch so that the poultry in the euthanasia room 6 drops down to the second conveyor 8. Then, the bottom of the euthanasia room 6 is automatically closed by the control switch. The euthanasia room 6 can be designed to have a predetermined loading. When the total weight of the poultry in the euthanasia room 6 reaches the predetermined loading amount, an alarm is triggered, and a sheet is lifted up. The transportation of the poultry from the poultry yard 2 to the euthanasia room 6 through the first conveyor 5 ceases. After the euthanasia is completed in the euthanasia room 6, the bottom of the euthanasia room 6 and the sheet return to their original positions, and the first conveyor 5 continues to transport additional poultry carcasses to the euthanasia room 6.

The poultry carcasses in the euthanasia room 6 are transported to the crusher 9 by the second conveyor 8 to be crushed. The crushed carcasses are transported to the incinerating means 11 by the third conveyor 10.

The incinerating means 1 has been disclosed in U.S. patent application Ser. No. 10/464,464, entitled “Animal Treatment System and Method Thereof”, filed by the inventor. The incinerating means 11 is used to incinerate the chunks transported to the incinerating means 11 by the third conveyor 10.

Alternately, a vacuum sucker is provided in the poultry yard 2 to pick up live poultry incapable of walking and to transport them to the first conveyor 5.

The vacuum sucker also picks up dead poultry in the poultry yard 2 and transports them to the second conveyor 8, or directly to the crusher 9 (as shown by a dotted arrow in FIG. 1) to crush to carcasses. Using this vacuum sucker instead of picking up the infected poultry by hand in the conventional technology can greatly eliminate the infection probability for the poultry keeper during the process of treating the infected poultry.

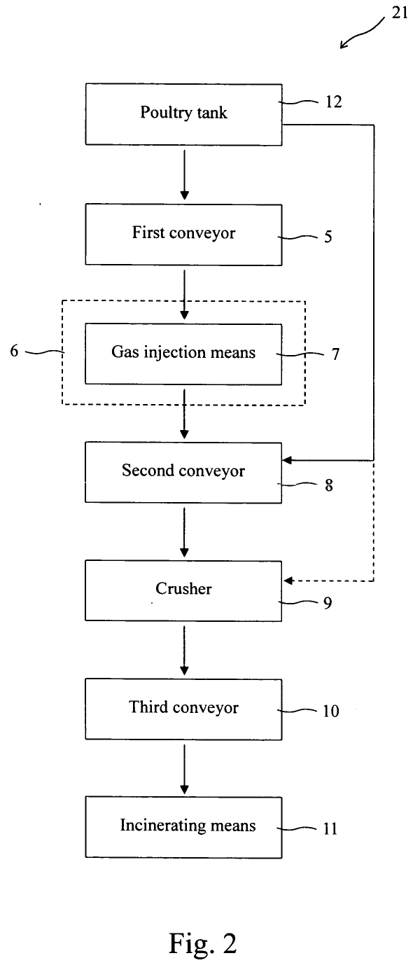

FIG. 2 is a schematic block diagram of the present infected poultry treatment system according to the second embodiment of the present invention, in which the present system has a ladder-type cage 12 instead of the poultry yard 2. The ladder-type cage 12 can be an elongated cage used for incubating hen's eggs. The live poultry, such as hens, in the ladder-type cage 12 can be picked up by the vacuum sucker and thereby transported to the first conveyor 5.

The dead hens in the ladder-type cage 12 also can be picked up by the vacuum suction means and thereby transported to the second conveyor 8, or directly transported to the crusher 9 (as shown by a dotted arrow in FIG. 2) to crush the carcasses.

The difference between the first embodiment and second embodiment is merely the means of gathering the poultry. The poultry yard 2 is used to gather the poultry in the first embodiment, and the ladder-type cage 12 is used to gather the poultry, such as hens, in the second embodiment. Therefore, the operation of the infected poultry treatment system of the second embodiment can be referred to that of the first embodiment. And, the enclosure for holding the infected poultry relies on the present treatment system.

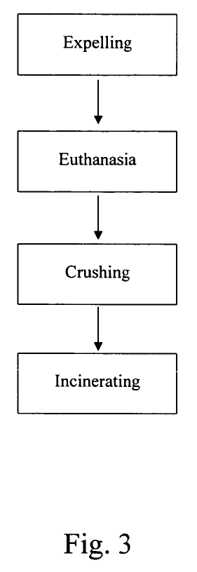

FIG. 3 is a schematic flow chart of a method of treating infected poultry of the present invention. The flow chart includes following steps:
(I) expelling: first, the fence 3 is used to narrow the space in the poultry yard 2, and the expelling mechanism 4 is driven in cooperation with the fence 3 to expel the poultry to the first conveyor 5 so as to transport the poultry to the euthanasia room 6;
(II) performing a euthanasia process: the gas injection means 7 introduces gas, such as carbon dioxide, into the euthanasia room 6 to kill the poultry. Thereafter, the bottom of the euthanasia room 6 is opened such that the dead poultry drops down to the second conveyor 8. The bottom of the euthanasia room 6 is opened and closed by the control switch;
(III) crushing: the dead poultry is transported to the crusher 9 through the second conveyor 8 to crush to the carcasses. The crushed carcasses are then transported to the incinerating means 11 by the third conveyor 10;
(IV) incinerating: the crushed carcasses are incinerated in the incinerating means 11.

The present infected poultry treatment system can be automatically and continuously operated for up to at least twenty-four hours. The working capacity is increased and the enclosure for holding the infected poultry relies on the design of the treatment system.

These embodiments are only used to illustrate the present invention, and are not intended to limit the scope thereof. Many modifications of the embodiments can be made without departing from the spirit of the present invention.

What is claimed is:

1. An infected poultry treatment system, comprising:
a poultry yard for holding the poultry to be treated;
a euthanasia room for introducing gas to kill the poultry;
a crusher for crushing dead poultry carcasses;
an incinerating means for incinerating the crushed carcasses;
a first conveyor for transporting the poultry from said poultry yard to said euthanasia room;
a second conveyor for transporting the dead poultry from said euthanasia room to said crusher; and
a third conveyor for transporting said crushed carcasses from said crusher to said incinerating means.

2. The infected poultry treatment system as claimed in claim 1, wherein said poultry yard further comprises a fence for narrowing a space in said poultry yard.

3. The infected poultry treatment system as claimed in claim 1, wherein said poultry yard further comprises an expelling mechanism for expelling the poultry in said poultry yard to said first conveyor.

4. The infected poultry treatment system as claimed in claim 1, wherein said euthanasia room comprises a gas injection means for introducing gas into said euthanasia room to kill the poultry.

5. The infected poultry treatment system as claimed in claim 4, further comprising an alarm, when the total weight of the dead poultry reaches a predetermined loading amount, said alarm is triggered and a sheet of said euthanasia room is lifted up so that the transportation between said poultry yard and said euthanasia room is ceased.

6. The infected poultry treatment system as claimed in claim 1, further comprising a vacuum sucker, said vacuum sucker being able to pick up the live poultry incapable of walking to transport the same to said crusher.

7. The infected poultry treatment system as claimed in claim 1, further comprising a vacuum sucker, said vacuum sucker being able to pick up dead poultry and transport the same to said crusher.

8. An infected poultry treatment system, comprising:
an enclosure for holding the poultry to be treated;
a crusher for crushing the poultry;
an incinerating means for incinerating the crushed carcasses;
a second conveyor for transporting the poultry from said enclosure to said crusher; and
a third conveyor for transporting the crushed carcasses from said crusher to said incinerating means.

9. The infected poultry treatment system as claimed in claim 8, wherein said enclosure is a ladder-type cage.

10. The infected poultry treatment system as claimed in claim 8, further comprising a vacuum sucker for picking up dead poultry in said enclosure and transporting the same to said second conveyor.

11. The infected poultry treatment system as claimed in claim 10, wherein said vacuum sucker is able to pick up the dead poultry and transport the same to said crusher.

12. A method for treating infected poultry, comprising the following steps:
automatically expelling the poultry to be treated so that the poultry is gathered for transportation;
performing a euthanasia process with gas to kill the poultry;
crushing dead poultry carcasses; and
incinerating the crushed carcasses.
